(19) United States
(12) Patent Application Publication
(10) Pub. No.: US 2013/0107072 A1
(43) Pub. Date: May 2, 2013

(54) MULTI-RESOLUTION IP CAMERA

(71) Applicants: Ankit Kumar, Bangalore (IN); Sudeep George Eraniose, Bangalore (IN); Arvind Kondangi Lakshmikumar, Bangalore (IN)

(72) Inventors: Ankit Kumar, Bangalore (IN); Sudeep George Eraniose, Bangalore (IN); Arvind Kondangi Lakshmikumar, Bangalore (IN)

(21) Appl. No.: 13/447,204

(22) Filed: Apr. 14, 2012

(30) Foreign Application Priority Data
Oct. 31, 2011 (IN) 3723/CHE/2011
Oct. 31, 2011 (IN) 3724/CHE/2011

(51) Int. Cl. H04N 5/228; G06K 9/62

(52) U.S. Cl. 348/222.1; 348/E05.031

(57) ABSTRACT

A device according to various embodiments receives two input images, enhances them, aligns them, fuses them, performs video analytics on the fused images, and encodes the images as part of a video stream that includes analytics meta data. In various embodiments, the use of certain algorithms enables efficient utilization and minimization of hardware, and results in a light-weight device. In various embodiments, the computation and inclusion of video analytics data lessens the burden on a network control center.

### RELATED APPLICATIONS

The present application claims the benefit of priority of Indian patent application number 3723/CHE/2011, entitled “MULTI-SPECTRAL IP CAMERA”, filed Oct. 31, 2011, and Indian patent application number 3724/CHE/2011, entitled “MULTI-SENSOR IP CAMERA WITH EDGE ANALYTICS”, filed Oct. 31, 2011, the entirety of each of which is hereby incorporated herein for all purposes.

### BACKGROUND

The number of sensors used for security applications is increasing rapidly, leading to a requirement for intelligent ways to present information to the operator without information overload, while reducing the power consumption, weight and size of systems. Security systems for military and paramilitary applications can include sensors sensitive to multiple wavebands including color visible, intensified visible, near infrared, thermal infrared and tera hertz imagers.

Typically, these systems have a single display that is only capable of showing data from one camera at a time, so the operator must choose which image to concentrate on, or must cycle through the different sensor outputs. Sensor fusion techniques allow for merging data from multiple sensors. Traditional systems employing sensor fusion operate at the server end, assimilating data from multiple sensors into one processing system and performing data or decision fusion.

Present day camera systems that support multi-sensor options may typically provide two ways of visualizing data from the sensors. One method is to toggle between the sensors based on user input. The other method is to provide a “Picture in Picture” view of the sensor imagery. Toggling can provide a view of only one sensor at any given time. “Picture in Picture” forces the operator to look at two images within a frame and interpret them.

It may be desirable to have means of providing a unified method of visualizing data from multiple sensors in real time. It may be desirable to have such a means within a compact, light-weight package.

Cameras used for critical installation security typically feed into a Video Management System that resides on a remote server. The feeds from the cameras are further analyzed at the server using intelligent video analytics to determine suspicious activity. However, requiring the server to analyze potentially numerous video feeds at once may place a burden on the server. Further, feeding one or more video streams to the server for analysis may strain communication pathways between cameras and server. In various embodiments, it may be desirable for a camera itself to perform analytics on captured video feeds.

### SUMMARY

Various embodiments allow for real-time fusion of multi-band imagery sources in one tiny, light-weight package, thus offering a real-time multi-sensor camera. Various embodiments maximize scene detail and contrast in the fused output, and may thereby provide superior image quality with maximum information content.

Various embodiments include a camera system that can improve the quality of long-wave infrared (LWIR) and electro-optical (EO) image sensors. Various embodiments include a camera system that can fuse the signals from the LWIR and EO sensors. Various embodiments include a camera system that can fuse such signals intelligently to image simultaneously in zero light and bright daylight conditions. Various embodiments include a camera system that can package the fused information in a form that is suitable for a security camera application.

Various embodiments include a camera that performs multiple functions within the same package. In various embodiments, the package consists of imaging sensors in the long wave IR spectrum and visible spectrum and an intelligent processing system. The processing system enhances the imagery, fuses the sensor data, performs automatic video analytics on the edge and sends out encoded video streams along with analytics meta-data. Where video analytics is performed at the edge of a network (e.g., at the location of the cameras rather than at a central server), the burden of processing at the server may be reduced, in some embodiments. Further, the burden of bandwidth transmission between cameras and server may be reduced, in some embodiments.

Various embodiments include an intelligent multi-sensor security camera that provides comprehensive day and night visualization coupled with edge based video analytics.

### BRIEF DESCRIPTION OF THE DRAWINGS

FIG. 1 depicts a block diagram of a device according to some embodiments.

FIG. 2 depicts exemplary hardware components for a device according to some embodiments.

FIG. 3 depicts a process flow according to some embodiments.

FIG. 4 depicts an illustration of an image fusion process, according to some embodiments.

FIG. 5 depicts a process flow according to some embodiments.

FIG. 6 depicts an exemplary illustration of part of an algorithm for image fusion, according to some embodiments.

FIG. 7 depicts an exemplary hardware sensor, according to some embodiments.

FIG. 8 depicts an exemplary hardware sensor, according to some embodiments.

FIG. 9 depicts exemplary hardware circuitry for performing video alignment, fusion, and encoding, according to some embodiments.

FIG. 10 depicts an exemplary network according to some embodiments.

### DETAILED DESCRIPTION

The following are incorporated by reference herein for all purposes:

U.S. Pat. No. 7,535,002, entitled “Camera with visible light and infrared image blending”, to Johson, et al., filed Jan. 19, 2007; U.S. Pat. No. 7,538,326, entitled “Visible light and IR combined image camera with a laser pointer”, to Johson, et al., filed Dec. 5, 2005; United States Patent Application No. 20100045809, entitled “INFRARED AND VISIBLE-LIGHT IMAGE REGISTRATION”, to Corey D. Packard, filed Aug. 22, 2008; United States Patent Application No. 20110001809, entitled “THERMOGRAPHY METHODS”, to Thomas J. McManus et al, filed Jul. 1, 2010.

The following is incorporated by reference herein for all purposes: Kirk Johnson, Tom McManus and Roger Schmidt, “Commercial fusion camera”, Proc. SPIE 6205, 62050H (2006); doi:10.1117/12.668933

Various embodiments include a multi-resolution image fusion system in the form of a standalone camera system. In various embodiments, the multi-resolution fusion technology integrates features available from all available sensors into one camera package. In various embodiments, the multi-resolution fusion technology integrates features available from all available sensors into one light-weight camera package. In various embodiments, the multi-resolution fusion technology integrates the best features available from all available sensors into one light-weight camera package.

Various embodiments enhance the video feed from each of the input sensors. Various embodiments fuse the complementary features. Various embodiments encode the resultant video feed. Various embodiments encode the resultant video feed into an H.264 video stream. Various embodiments transmit the video feed over a network. Various embodiments transmit the video feed over an IP network.

In various embodiments, the multi-resolution fusion technology integrates the best features available from all available sensors into one light-weight camera package, enhances the video feed from each of the input sensors, fuses the complementary features, encodes the resultant video feed into a H.264 video stream and transmits it over an IP network.

In various embodiments, sensor image feeds are enhanced in real-time to get maximum quality before fusion. In various embodiments, sensor fusion is done at a pixel level to avoid loss of contrast and introduction of artifacts.

In various embodiments, video analytics is performed on the fused feed. Video analytics may be used to detect various scenarios or situations. In various embodiments, video analytics may be used for: motion detection; moving object tracking; moving target geo-location; perimeter breach; and abandoned object detection; object removal detection.

In various embodiments, the resultant fused feed is available as a regular IP stream that can be integrated with existing security cameras.

A multi-sensor camera according to some embodiments overcomes the limitations of a single sensor vision system by combining the images from imagery in two spectrums to form a composite image.

A camera according to various embodiments may benefit from an extended range of operation. Multiple sensors that operate under different operating conditions can be deployed to extend the effective range of operation.

A camera according to various embodiments may benefit from extended spatial and temporal coverage. In various embodiments, joint information from sensors that differ in spatial resolution can increase the spatial coverage.

A camera according to various embodiments may benefit from reduced uncertainty. In various embodiments, joint information from multiple sensors can reduce the uncertainty associated with the sensing or decision process.

A camera according to various embodiments may benefit from increased reliability. In various embodiments, the fusion of multiple measurements can reduce noise and therefore improve the reliability of the measured quantity.

A camera according to various embodiments may benefit from robust system performance. In various embodiments, redundancy in multiple measurements can help in systems robustness. In the event that one or more sensors fail or the performance of a particular sensor deteriorates, the system can depend on the other sensors.

A camera according to various embodiments may benefit from compact representation of information. In various embodiments, fusion leads to compact representations. Instead of storing imagery from several spectral bands, it is comparatively more efficient to store the fused information.

A camera according to various embodiments may benefit from providing video analytics at the camera level. Thus, the camera may take burden off a server or other device from having to analyze the camera's video feed. In various embodiments, in a network of two or more camera, the reduced burden on the part of the server may become significant. In various embodiments, video analytics performed at the camera level may reduce the necessity of transmitting any, or as much information over a network. For example, in some embodiments, rather than transmitting a full video stream over an IP network for analysis by a server, a camera may instead transmit the results of video analytics that it has performed. These results may constitute significantly less information than does the full video stream, and may thus take up less bandwidth on the network, less storage on the part of the server, less processing on the part of the server, etc. In some embodiments, a camera may transmit results of video analytics, together with a more compressed version of a its video stream than would otherwise be necessary to generate the video analytics in the first place. Thus, the camera may save bandwidth, while still transmitting a video feed and the results of video analytics.

A camera according to various embodiments provides data from multiple sensor feeds available as a single unified feed.

A camera according to various embodiments performs video analytics on the edge (e.g., on the edge of a network) on an enhanced video feed. This may improve the quality of analytics and may also yield reduced rates of false alarms (e.g., versus analytics performed solely at a control center).

A camera according to various embodiments, provides enhanced video and analytics meta data that are jointly available through a single feed to a video management system.

A camera according to various embodiments, by performing video analytics, may reduce the number of servers and processing systems required at the command and control centre of a security installation.

Various embodiments include a camera system capable of real-time pixel level fusion of long wave IR and visible light imagery.

Various embodiments include a single camera unit that performs sensor data acquisition, fusion and video encoding.

Various embodiments include a single camera capable of multi-sensor, depth of focus and dynamic range fusion.

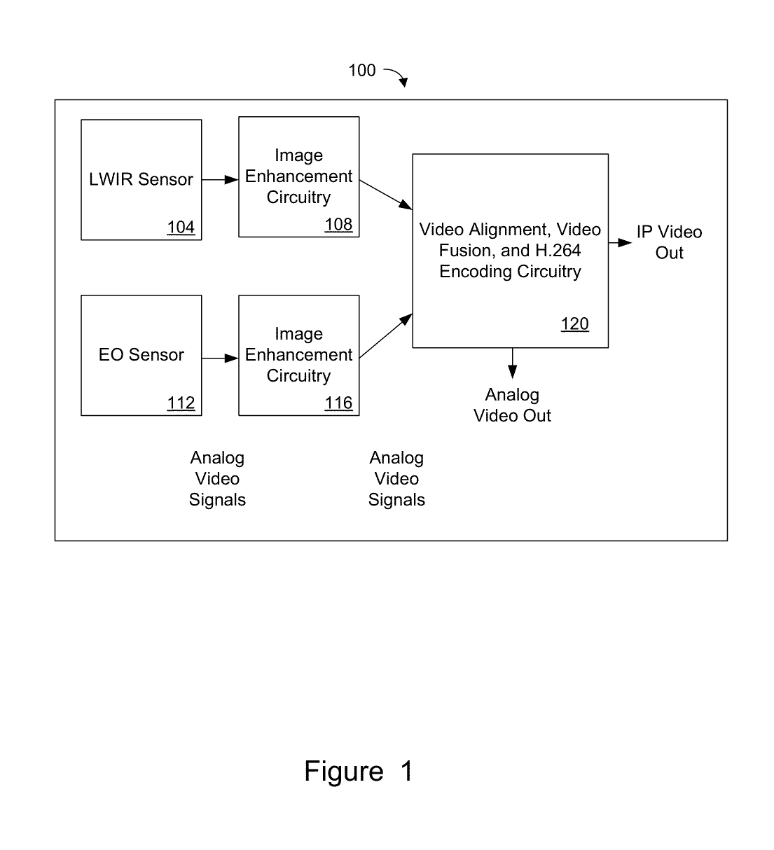

Referring to FIG. 1, a block diagram of a device 100 is shown according to some embodiments. The device includes long wave infrared (LWIR) sensor 104, image enhancement circuitry 108, electro-optical (EO) sensor 112, image enhancement circuitry 116, and circuitry for video alignment, video fusion, and H.264 encoding 120. In operation, the device 100 may be operable to receive one or more input signals, and transform the input signals in stages.

A first input signal may be received at the LWIR sensor 104, and may include an incident LWIR signal. The first input signal may represent an image captured in the LWIR spectrum. The sensor 104 may register and/or record the signal in digital format, such as an array of bits or an array of bytes. As will be appreciated, there are many ways by which the input signal may be recorded. In some embodiments, the input signal may be registered and/or recorded in analog forms. The signal may then be passed to image enhancement circuitry 108, which may perform one or more operations or transformations to enhance the incident signal.

On a parallel track, a second input signal may be received at the EO sensor 112. The second input signal may include an incident signal in the visible light spectrum. The second input signal may represent an image captured in the visible light spectrum. The sensor 112 may register and/or record the signal in digital format, such as an array of bits or an array of bytes. As will be appreciated, there are many ways by which the input signal may be recorded. In some embodiments, the input signal may be registered and/or recorded in analog forms. The signal may then be passed to image enhancement circuitry 116, which may perform one or more operations or transformations to enhance the incident signal.

It will be appreciated that, whereas a given stage (e.g., LWIR sensor, EO sensor 112, Image Enhancement Circuitry 108, Image Enhancement 116) may operate on a single image at a given instant of time, such sensors may perform their operations repeatedly in rapid succession, thereby processing a rapid sequence of images, and thereby effectively operating on a video.

Image enhancement circuitry 108, and image enhancement circuitry 116 may, in turn, pass their respective output signals to circuitry 120, for the process of video alignment, video fusion, and H.264 encoding.

LWIR sensor 104 may take various forms, as will be appreciated. An exemplary LWIR sensor may include an uncooled microbolometer based on an ASi substrate manufactured by ULIS.

EO sensor 112 may take various forms, as will be appreciated. EO sensor may include a charge-coupled device (CCD), a complementary metal-oxide semiconductor (CMOS) active pixel sensor, or any other image sensor. EO sensor may include a lens, shutter, illumination source (e.g., a flash), a sun shade or light shade, mechanisms and/or circuitry for focusing on a target, mechanisms and/or circuitry for automatically focusing on a target, mechanisms and/or circuitry for zooming, mechanisms and/or circuitry for panning, and/or any other suitable component. An exemplary EO sensor may include a CMOS sensor manufactured by Omnivision.

Image enhancement circuitry 108 may include one or more special purpose processor, such as digital signal processors (DSPs) or graphics processing units. Image enhancement circuitry 108 may include general purpose processors. Image enhancement circuitry 108 may include custom integrated circuits, field programmable gate arrays, or any other suitable circuitry. In various embodiments, image enhancement circuitry 108 is specifically programmed and/or designed for performing image enhancement algorithms quickly and efficiently. Image enhancement circuitry 116 may, in various embodiments, include circuitry similar to that of circuitry 108.

Circuitry 120 may receive input signals from the outputs of image enhancement circuitry 108 and image enhancement circuitry 116. The signals may comprise image signals and/or video signals. The signals may be transmitted to circuitry 120 via any suitable connector or conductor, as will be appreciated. Circuitry 120 may then perform one or more algorithms, processes, operations and/or transformations on the input signals.

Processes performed may include video alignment, which may ensure that features present in the respective input signals are properly aligned for combination. As will be appreciated, signals originating from LWIR sensor 104 and from EO sensor 112 may both represent captured images and/or videos of the same scene. It may thus be desirable that these two images and/or videos are aligned, so that information about a given feature in the scene can be reinforced from the combination of the two signals.

In some embodiments, as the LWIR sensor 104 and EO sensor 112 may be at differing physical positions, the scene captured by each will be from slightly differing vantage points, and may thus introduce parallax error. The process of video alignment may seek to minimize and/or correct this parallax error, in some embodiments.

Circuitry 120 may also be responsible for video fusion, which may include combining the two signals originating from the respective sensors into a single, combined signal. In various embodiments, the combined signals may contain more information about the captured scene than do one or either of the original signals.

Circuitry 120 may also be responsible for video encoding, which may include converting the combined video signal into a common or recognized video format, such as the H.264 video format.

Circuitry 120 may output one or more video signals, which may include a video signal in common format, such as an H.264 video signal. In some embodiments, circuitry 120 may include a port or interface for linking to an internet protocol (IP) network. The circuitry 120 may be operable to output a video signal over an IP network.

In various embodiments, camera 100 may include one or more additional components, such as a view finder, viewing panel (e.g., a liquid crystal display panel for showing an image or a fused image of the camera), power source, power connector, memory card, solid state drive card, hard drive, electrical interface, universal serial bus connector, sun shade, illumination source, flash, and any other suitable component. Components of camera 100 may be enclosed within, and/or attached to a suitable housing, in various embodiments. Whereas various components have been described as separate or discrete components, it will be appreciated that, in various embodiments, such components may be physically combined, attached to the same circuit board, part of the same integrated circuit, utilize common components (e.g., common processors; e.g., common signal busses), or otherwise coincide. For example, in various embodiments, image enhancement circuitry 108 and image enhancement circuitry 116 may be one and the same, and may be capable of simultaneously or alternately operating on input signals from both the LWIR sensor 104 and from the EO sensor 112.

It will be appreciated that certain components that have been described as singular may, in various embodiments, be broken into multiple components. For example, in some embodiments, circuitry 120 may be instantiated over two or more separate circuit boards, utilize two or more integrated circuits or processors, and so on. Where there are multiple components, such components may be near or far apart in various embodiments.

Whereas various embodiments have described LWIR and EO sensors, it will be appreciated that other types of sensors may be used, and that sensors for other portions of the electromagnetic spectrum may be used, in various embodiments.

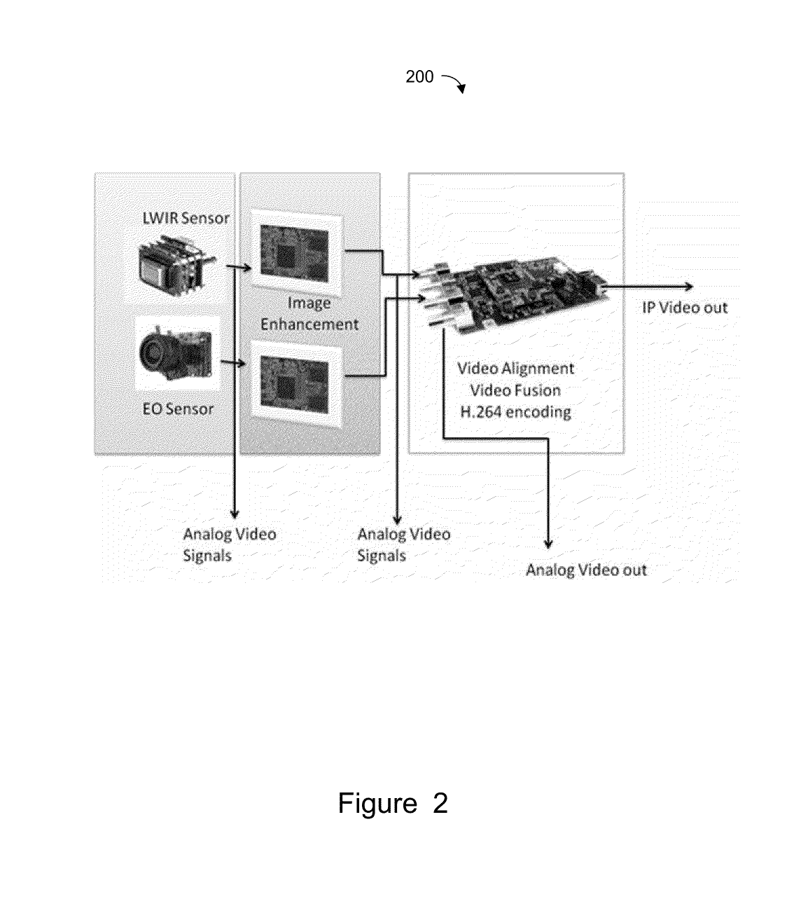

Referring to FIG. 2, an exemplary hardware implementation is shown for components/modules 104, 112, 108, 116, and 120, in various embodiments.

Various embodiments utilize hardware on an FPGA system with DSP coprocessors. In some embodiments, the multi-sensor camera performs algorithms on a Texas Instruments DaVinci chip.

In various embodiments, a hardware implementation allows for an advantageously light camera. In various embodiments, a camera weighs in the vicinity of 1.2 kg. The camera may minimize weight by utilizing a light-weight LWIR sensor, and/or by utilizing a light-weight DSP board that performs both video capture and processing on a single board.

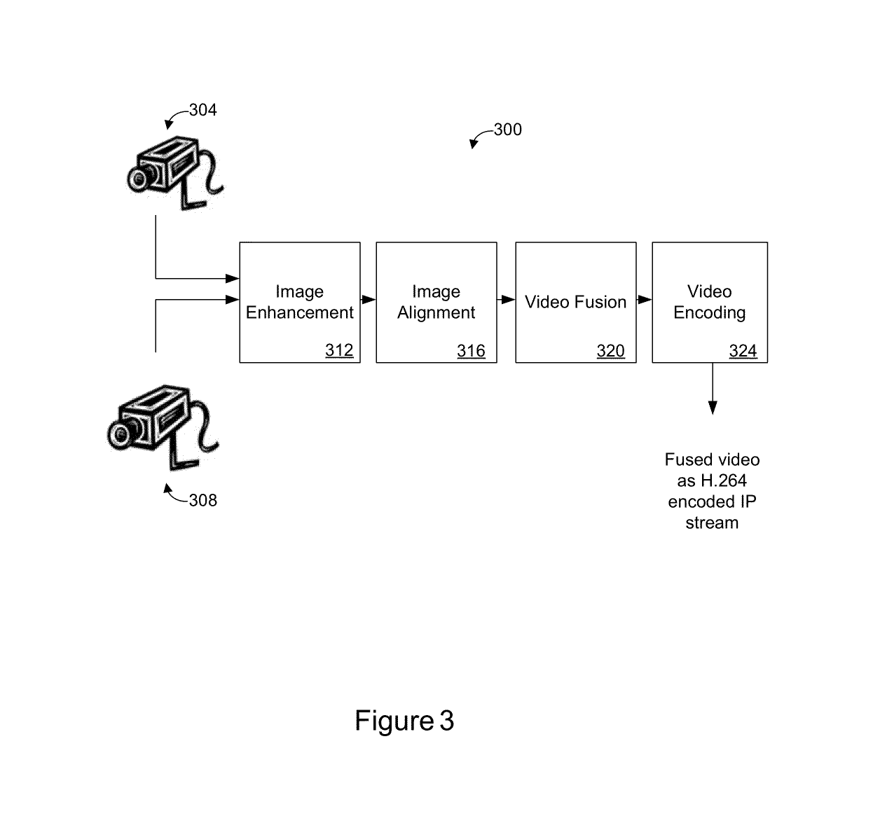

Referring to FIG. 3, a process flow is depicted according to some embodiments. In various embodiments, the process flow indicates successive transformations of input image signals into output image signals. In various embodiments, the process flow indicates successive transformations of input video signals into output video signals. In various embodiments, the process flow indicates successive transformations of input video signals into an output video signal.

Initially, input signals may come from sensor 304, and from sensor 308. These may correspond respectively to LWIR sensor 104, and to EO sensor 116. However, as will be appreciated, other types of sensors may be used, in various embodiments (e.g., sensors for different portions of the spectrum). In various embodiments, input signals may be derived from other sources. For example, input signals may be derived over a network or from an electronic storage medium. For example, the input signals may represent raw, pre-recorded video signals.

In various embodiments, there may be more than two input signals. For example, there may be three or more input signals, each stemming from a different sensor. In some embodiments, input sensors may include a short wave infrared (SWIR) sensor, a LWIR sensor, and a visible light sensor.

At step 312, a process of image enhancement may be performed. Image enhancement may include altering or increasing sharpness, brightness, contrast, color balance, or any other aspect of the image. Image enhancement may include reducing blur. Image enhancement may be performed via digital manipulation, e.g., via manipulation of pixel data. In some embodiments, image enhancement may occur via manipulation of analog image data. In some embodiments, image enhancement may include the application of one or more filters to an image. In various embodiments, image enhancement may include the application of any algorithm or transformation to the input image signal. As will be appreciated, image enhancement, when applied to frames of a video signal, may include video enhancement.

At step 316, a process of image alignment may occur. Image alignment may operate on image signals originating, respectively, from image enhancement circuitry 108, and from image enhancement circuitry 116. In the process of image alignment, two separate images may be compared. Common signals, features, colors, textures, regions, patterns, or other characteristics may be sought between the two images. A transformation may then be determined which would be necessary to bring such common signals, features, etc., into alignment. For example, it may be determined that shifting a first image a certain number of pixels along a notional x-axis and y-axis may be sufficient to align the first image with a second image that is also presumed to fall within the same coordinate system. As will be appreciated, in various embodiments, other transformations may be utilized in the process of image alignment. For example, transformations may include shifting, rotating, or scaling.

At step 320, video fusion may be performed. Video fusion may include combining images from each of two input video streams. Such input video streams may consist of images that have been aligned at step 316. Video fusion may be performed in various ways, according to various embodiments. In some embodiments, data from two input images may be combined into a single image. The single image may contain a better representation of a given scene than do one or both of the input images. For example, the single image may contain less noise, finer detail, better contrast, etc. The process of video fusion may include determining the relative importance of the input images, and determining an appropriate weighting for the contribution of the respective input images. For example, if a first input image contains more detail than does a second input image, then more information may be used from the first image than from the second image in creating the fused image.

In various embodiments, a weighting determination may be made on more localized basis than on an entire image. For example, a certain region of a first image may be deemed more important than an analogous region of a second image. However, another region of the first image may be deemed less important than its analogous region in the second image. Thus, different regions of a given image may be given different weightings with respect to their contribution to a fused image. In some embodiments, weightings may go down to the pixel level. In some embodiments, weightings may be applied to images in some transform domain (e.g., in a frequency domain). In such cases, relative contributions of the two images may differ by frequency (or other metric) in the transform domain.

In various embodiments, other methods may be used for combining or fusing images and/or videos.

In various embodiments a fusion algorithm may be used for different wavelengths, different depths of field and/or different fields of view.

In various embodiments, a determination may be made as to whether or not a sensor is functional, and/or whether or not the sensor is functioning properly. If the sensor is not functioning properly, or not functioning at all, then video input from that sensor may be disregarded. For example, video input from the sensor may be omitted in the fusion process, and the fusion process may only utilize input from remaining sensors.

In various embodiments, an image quality metric is derived in order to determine if input from a given sensor is of good visual quality. In various embodiments, the image quality metric is a derivative of the singular value decomposition of local image gradient matrix, and provides a quantitative measure of true image content (i.e., sharpness and contrast as manifested in visually salient geometric features such as edges,) in the presence of noise and other disturbances. This measure may have various advantages in various embodiments. Advantages may include that the image quality metric 1) is easy to compute, 2) reacts reasonably to both blur and random noise, and 3) works well even when the noise is not Gaussian.

In various embodiments, the image quality metric may be used to determine whether or not input from a given sensor should be used in a fused video signal.

At step 322 video analytics may be performed. In some embodiments, video analytics is performed on the fused image. In some embodiments, video analytics may be performed on a feed prior to fusing. For example, in some embodiments, video analytics may be performed on the feed from only one sensor.

In some embodiments, video analytics may be used to output various data, information, intelligence and/or analysis of an image. Video analytics may be a form of interpretation of an image or video, and may allow classification and/or decision making based on the results of the analysis. For example, in a security application, video analytics may seek to determine whether an intruder is detected in a video, or whether a valuable object is absent from an image. Many applications are possible and are contemplated, according to various embodiments.

In various embodiments, video analytics may be used to determine the presence of motion, the presence of a particular type of object (e.g., person, vehicle, suspicious package, animal, adverse weather pattern, etc.), the absence of an object (e.g., the disappearance of jewelry), the trajectory of an object, the speed of an object, the location of an object, the overlapping of an object with a known boundary or landmark, and so on. In various embodiments, video analytics may be used to identify an object. For example, video analytics may be used to identify an individual person, e.g., using facial recognition. For example, video analytics may be used to determine a type of animal. In some embodiments, video analytics may be used to read characters, such as those on a license plate.

In various embodiments, an end result of the performance of video analytics may include a tag, an identifier, a code, meta-data, or some other indication of the findings. For example, a tag may read “person” in order to indicate that a person was identified in a video. A shorter representation code may also be used, such as “p” for person, in some embodiments. As will be appreciated, various other tags or meta-data may be used. As another example, a tag may read, “northeast, 35 kph” to indicate that an object has been identified moving northeast at 35 kilometers per hour.

At step 324, video encoding may be performed. Video encoding may be used to compress a video signal, prepare the video signal for efficient transmission, and/or to convert the signal into a common, standard, or recognized format that can be replayed by another device. The process of video encoding may convert the fused video signal into any one or more known video formats, such as MPEG-4 or H.264. Following the encoding process, an output signal may be generated that is available for transmission, such as for transmission over an IP network.

In various embodiments, an output signal may include data or information resultant from video analytics. The data from the video analytics may be linked or synchronized to the output signal, so that it is clear what portion of the output signal yielded the analysis. For example, in some embodiments, an identifying tag of “automobile present” may be lined to “frames 1004 through 1589” of a video signal. As will be appreciated, many other ways of linking video analytics data to corresponding portions of a video output signal are possible and are contemplated in various embodiments.

In various embodiments, some portion or segment of fused video data may be stored prior to transmission, such as transmission over an IP network. In some embodiments, fused video data is transmitted immediately, and little or no data may be stored. In various embodiments, some portion or segment of encoded video data may be stored prior to transmission, such as transmission over an IP network. In some embodiments, encoded video data is transmitted immediately, and little or no data may be stored.

Whereas FIG. 3 depicts a certain order of steps in a process flow, it will be appreciated that, in various embodiments, an alternative ordering of steps may be possible. For example, in various embodiments, image enhancement may occur after image alignment, or image enhancement may occur after video fusion.

In various embodiments, more or fewer steps may be performed than are shown in FIG. 3. For example, in some embodiments, the step of image enhancement may be omitted.

### Image Registration and Alignment

In various embodiments, video analytics may involve image registration and alignment.

### Affine Global Motion Estimation

In various embodiments, each of the source images (e.g., images from the fused video feed) is registered into a common coordinate frame using affine global motion estimation.

### Local Motion Estimation

In various embodiments, local unconstrained motion estimation is performed to register local scene structure in the source images that may be in motion. This is accomplished through estimating an optical flow field between each source image and a common reference image, and using that flow field to warp the source images such that all scene features are in accurate registration

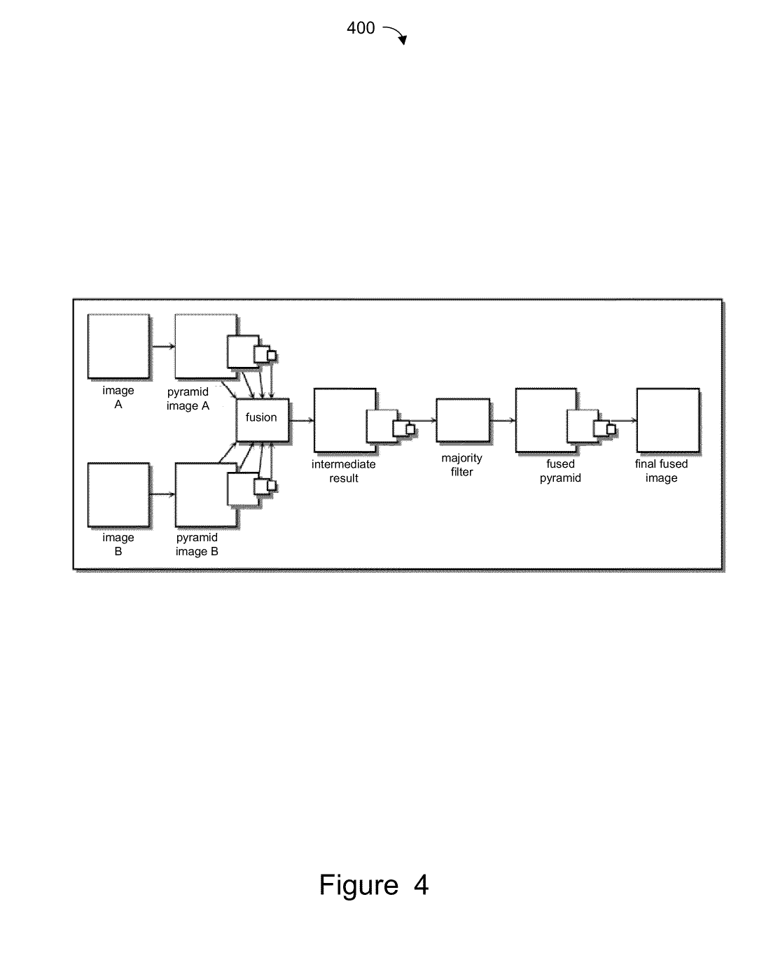

FIG. 4 depicts an illustration of fusion process 320, illustrating processes and intermediate results, according to some embodiments. As will be appreciated, image fusion and video fusion may be related processes, as the latter may consist of repeated application of the former, in various embodiments.

While fusing data from different sources, it may be desirable to preserve the more significant detail from each of the video streams on a pixel by pixel basis. An easy combination of the video streams is to perform an averaging function of the two video streams. However, contrast is reduced significantly and sometimes detail from one stream cancels detail from the other stream. The Laplacian pyramid fusion on the other hand may provide excellent automatic selection of the important image detail for every pixel from both images at multiple image resolutions. By performing this selection in the multiresolution representation, the reconstructed—fused—image may provide a natural-looking scene.

In addition, the Laplacian pyramid fusion algorithm allows for additional enhancement of the video. It can provide multi-frequency sharpening, contrast enhancement, and selective de-emphasis of image detail in either video source.

Laplacian pyramid fusion is a pattern selective fusion method that is based on selecting detail from each image on a pixel by pixel basis over a range of spatial frequencies. This is accomplished in three basic steps (assuming the source images have already been aligned). First, each image is transformed into a multiresolution, bandpass representation, such as the Laplacian pyramid. Second, the transformed images are combined in the transform domain—i.e. combine the Laplacian pyramids on a pixel by pixel basis. Finally, the fused image is recovered from the transform domain through an inverse transform—i.e. Laplacian pyramid reconstruction.

The Laplacian pyramid is derived from a Gaussian pyramid. The Gaussian pyramid is obtained by sequence of filter and subsample steps. First a low pass filter is applied to the original image G0. The filtered image is then subsampled by a factor of two providing level 1 of the Gaussian pyramid, G1. The subsampling can be applied since the spatial frequencies have been limited to half the sample frequency. This process is repeated for N levels computing G2 . . . GN.

The Laplacian pyramid is obtained by taking the difference between each of the Gaussian pyramid levels. These are often referred to as DoG (difference of Gaussians). So Laplacian level 0 is the difference between G0 and G1. Laplacian level 1 is the difference between G1 and G2. The result is a set of bandpass images where L0 represents the upper half of the spatial frequencies (all the fine texture detail), L1 represents the frequencies between ¼ and ½ the full bandwidth, L2 represents the frequencies between ⅛ and ¼ the full bandwidth, etc.

This recursive computation of the Laplacian pyramid is a very efficient method for computing effectively very large filters with one small filter kernel.

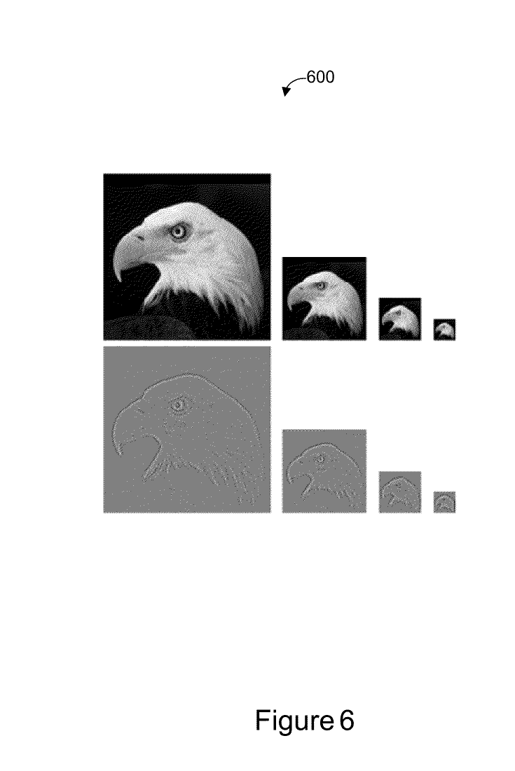

FIG. 6 depicts an example of a Gaussian and Laplacian pyramid 600.

Further, the Laplacian pyramid plus the lowest level of the Gaussian pyramid, represent all the information of the original image. So an inverse transform that combines the lowest level of the Gaussian pyramid with the Laplacian pyramid images, can reconstruct the original image exactly.

When using the Laplacian pyramid representation as described above, certain dynamic artifacts in video scenes will be noticeable. This often manifests itself as “flicker” around areas with reverse contrast between the image. This effect is magnified by aliasing that has occurred during the subsampling of the images.

Double density Laplacian pyramids are computed using double the sampling density of the standard Laplacian pyramid. This requires larger filter kernels, but can still be efficiently implemented using the proposed hardware implementation in the camera. This representation is essential in reducing the image flicker in the fused video.

Most video sources are represented as an interlaced sequence of fields. RS170/NTSC video has a 30 Hz frame rate, where each frame consists of 2 fields that are captured and displayed 1/60 sec. apart. So the field rate is 60 Hz. The fusion function can operate either on each field independently, or operate on full frames. By operating on fields there is vertical aliasing present in the images, which will reduce vertical resolution and increase image flicker in the fused video output. By operating the fusion on full frames, the flicker is much reduced, but there may be some temporal artifacts visible in areas with significant image motion.

In various embodiments, pixel selective fusion may include the following steps. Pyramids are formed for the input images. Feature saliency measures are computed for the input images based on their pyramid representations. A selection process is operated on the saliency pyramid, generating a coefficient pyramid that is used for final fusing. The fused image result is reconstructed from the pyramids of the original images subject to the coefficients generated by the selection process.

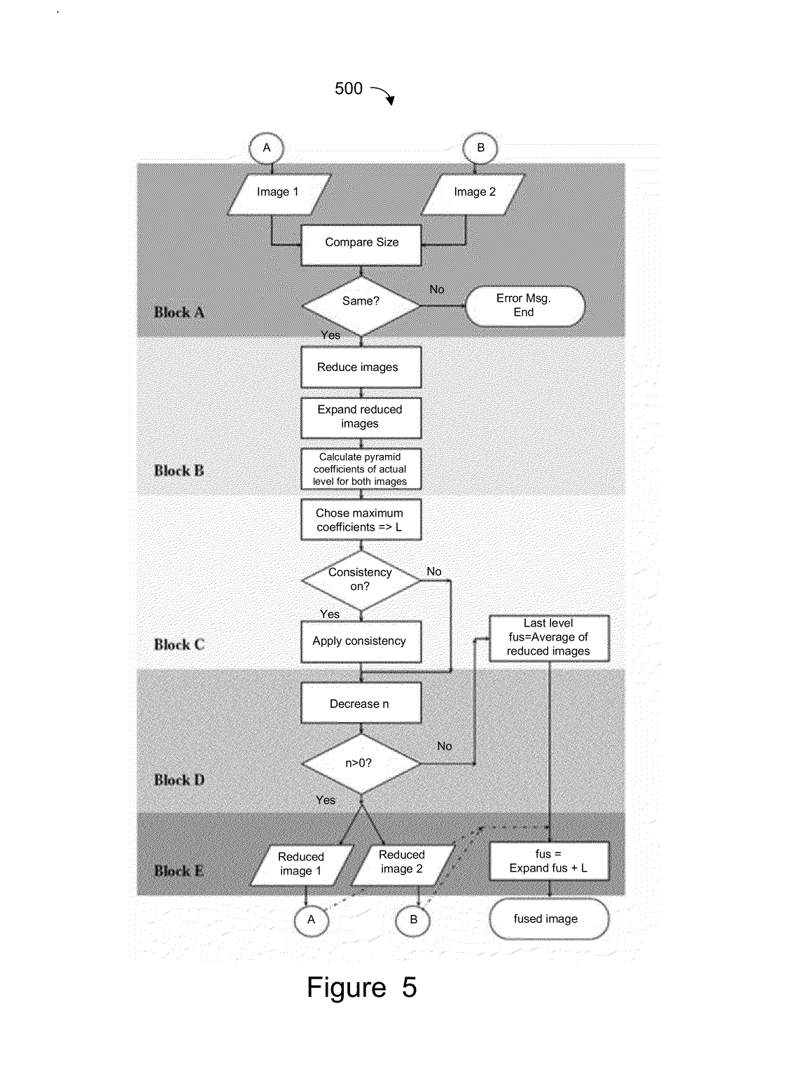

FIG. 5 depicts a process flow for image fusion, according to some embodiments. The recursive process takes two images 502 and 504 as inputs. At step 506, the image sizes are compared. If the images are not the same size, the process flow ends with an error 510.

If the images are the same size, the images are reduced at step 512. The images may be reduced by sub-sampling of the images. In some embodiments, a filtering step is performed on the images before sub-sampling (e.g., a low pass filter is applied to the image before sub-sampling). The reduced images are then expanded at step 514. The resultant images will represent the earlier images but with less detail, as the sub-sampling will have removed some information.

At step 516, pyramid coefficients of the actual level for both images are calculated. Pyramid coefficients may represent possible weightings for each of the respective images in the fusion process. Pyramid coefficients may be calculated in various ways, as will be appreciated. For example, in some embodiments, coefficients may be calculated based on a measure of spatial frequency detail and/or based on a level of noise.

At step 518, maximum coefficients are chosen, which then results in fused level L.

At step 520, it is determined whether or not consistency is on. Consistency may be a user selectable or otherwise configurable setting, in some. In some embodiments, applying consistency may include ensuring that there is consistency among chosen coefficients at different iterations of process flow 500. Thus, for example, in various embodiments, applying consistency may include altering the coefficients determined at step 518. If consistency is on, then flow proceeds to step 522, where consistency is applied. Otherwise, step 522 is skipped.

At step 524, a counter is decreased. The counter may represent the level of recursion that will be carried out in the fusion process. For example, the counter may represent the number of levels of a Laplacian or Gaussian pyramid that will be employed. If, at 526, the counter has not yet reached zero, then the algorithm may run anew on reduced image 1 528, and reduced image 2 530, which may become image 1 502, and image 2 504, for the next iteration. At the same time, the fused level L may be added to the overall fused image 536 at step 534. If, on the other hand, the counter has reached zero at step 526, then flow proceeds to step 532, where the fused level becomes the average of the reduced images. This average is in turn combined with the overall fused image 530.

Ultimately, upon completion of all levels of recursion of the algorithm, the fused image 530 will represent the separately weighted contributions of multiple different pyramid levels stemming from original image 1 and original image 2.

Whereas FIG. 5 depicts a certain order of steps in a process flow, it will be appreciated that, in various embodiments, an alternative ordering of steps may be possible. Also, in various embodiments, more or fewer steps may be performed than are shown in FIG. 5.

It will be appreciated that, whereas certain algorithms are described herein, other algorithms are also possible and are contemplated. For example, in various embodiments other algorithms may be used for one or more of image enhancement and fusion.

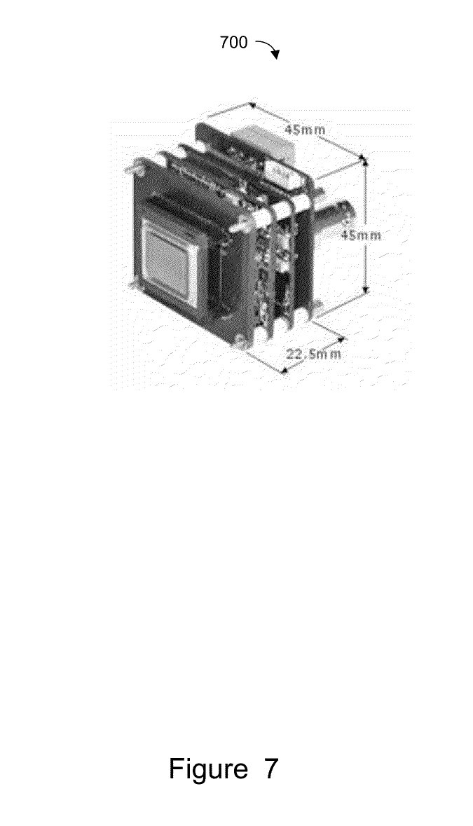

FIG. 7 depicts an exemplary hardware implementation 700 of LWIR sensor 104, according to some embodiments. As will be appreciated, other hardware implementations are possible and contemplated, according to various embodiments.

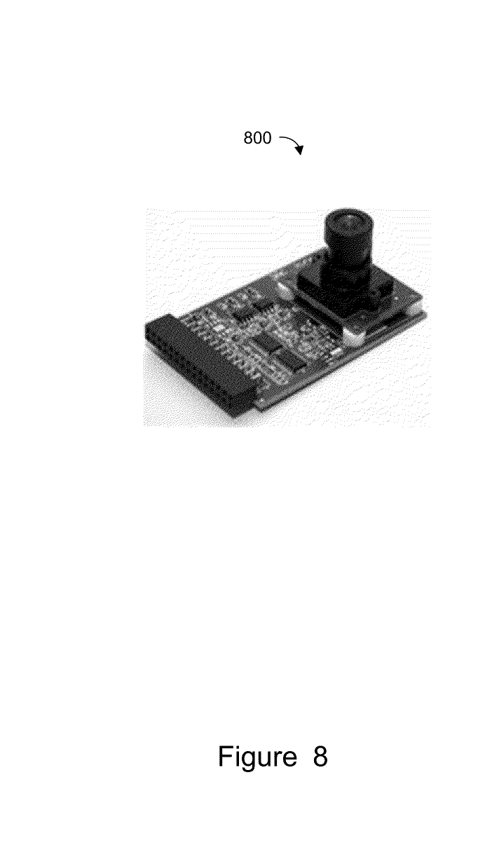

FIG. 8 depicts an exemplary hardware implementation 800 of EO sensor 112, according to some embodiments. As will be appreciated, other hardware implementations are possible and contemplated, according to various embodiments.

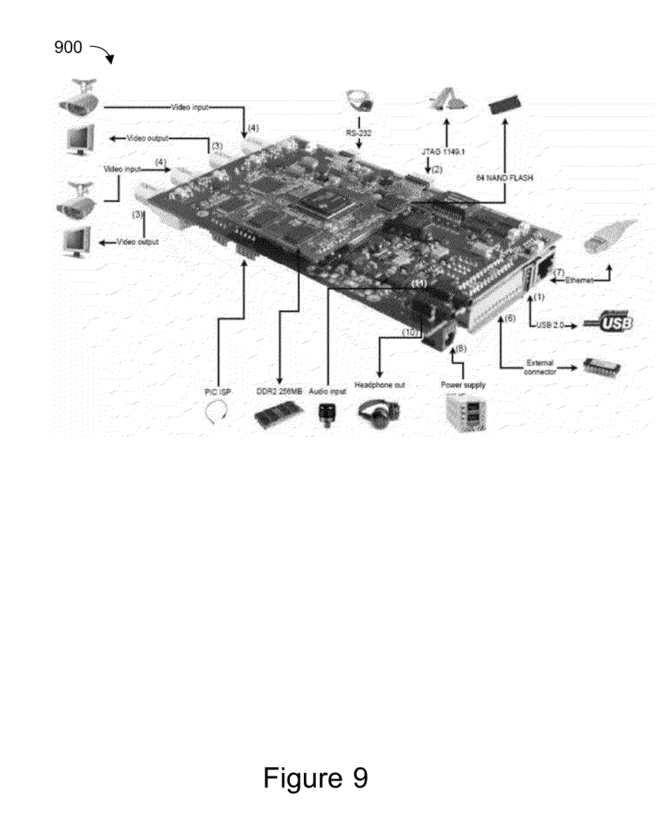

FIG. 9 depicts an exemplary hardware implementation 900 for circuitry 120 for performing video alignment, fusion, and encoding, according to some embodiments. As will be appreciated, other hardware implementations are possible and contemplated, according to various embodiments. The circuitry 900 may include various components, including video input terminals, video output terminals, RS232 connector (e.g., a serial port), a JTAG port, an Ethernet port, a USB drive, an external connector (e.g., for plugging in integrated circuit chips), a connector for a power supply, an audio input terminal, an audio output terminal, a headphones output terminal, and a PIC ISP (e.g., a connection or interface to a microcontroller). The circuitry may include various chips or integrated circuits, such as a 64 NAND flash chip, DDR2 256 MB chip. These may support common computer functions, such as providing storage and dynamic memory.

As will be appreciated, in various embodiments, alternative hardware implementations and components are possible. In various embodiments, certain components may be combined, or partially combined. In various embodiments, certain components may be separated into multiple components, which may divide up the pertinent functionalities.

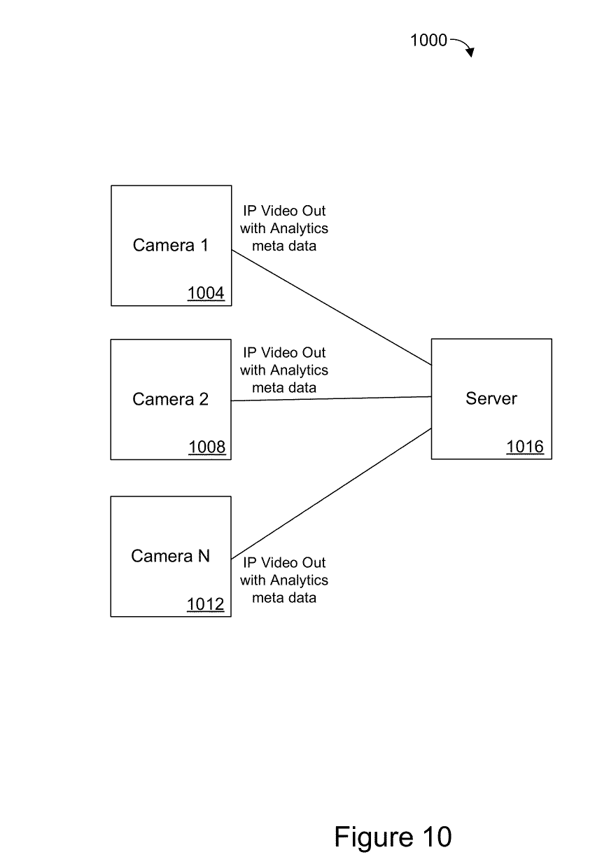

FIG. 10 depicts an exemplary network 1000 according to some embodiments. The network may include one or more cameras. As depicted, the network includes camera 1 1004, camera 2 1008, and camera N 1012. As will be appreciated, any number of cameras may be present. The network further includes server 1016. Server 1016 may receive feeds from the cameras in the network. Such feeds may include video streams. Such feeds may further include video analytics meta data associated with the video streams. As will be appreciated, in various embodiments, the cameras may communicate with multiple servers. For example, a command center may include multiple servers, and such servers may be collocated or in disparate locations. Network 1000 may represent a network of security cameras, traffic monitoring cameras, perimeter monitoring cameras, wildlife monitoring cameras, weather cameras, or any other network of cameras, as will be appreciated. The network may serve to derive information and/or intelligence in a systematic, semi-automated, or fully automated manner.

As will be appreciated, with many cameras in the network 1000, the burden on server of gathering intelligence from all of the video feeds may become significant, as may the bandwidth utilization going into the server. Thus, in various embodiments, the network may benefit from having video analytics performed at the location of the cameras rather than at the location of the server.

### Image Enhancement

Because the fusion function operates in the Laplacian pyramid transform domain, several significant image enhancement techniques may be readily performed, in various embodiments.

### Peaking and Contrast Enhancement

Various embodiments may employ a technique to make video look sharper by boosting the high spatial frequencies. This may be accomplished by adding a gain factor to Laplacian level 0. This “sharpens” the edges and fine texture detail in the image.

Since the Laplacian pyramid consists of several frequency bands, various embodiments contemplate boosting the lower spatial frequencies, which effectively boosts the image contrast. Note that peaking often results in boosting noise also. So the Laplacian pyramid provides the opportunity to boost level 1 instead of level 0, which often boosts the important detail in the image, without boosting the noise as much.

In various embodiments, the video from each of the sensors (e.g., sensors 104 and 112) is enhanced before it is presented to the fusion module. The fusion system accepts the enhanced feeds and then fuses the video.

In various embodiments, the input feeds may be fused first and then the resultant video may be enhanced.

### Selective Contribution

In various embodiments, the fusion process combines the video data on each of the Laplacian pyramid levels independently. This provides the opportunity to control the contribution of each of the video sources for each of the Laplacian levels.

For example, if the IR image does not have much high spatial frequency detail, but has a lot of noise, then it is effective to reduce the contribution at L0 from the IR image. It is also possible that very dark regions of one video source reduce the visibility of details from the other video source. This can be compensated for by changing the contribution of the lowest Gaussian level.

### Image Enhancement

The following are incorporated by reference herein for all purposes:

U.S. Pat. No. 5,912,993, entitled “Signal encoding and reconstruction using pixons”, to Puetter, et al., filed Jun. 8, 1993; U.S. Pat. No. 6,993,204, entitled “High speed signal enhancement using pixons”, to Yahil, et al., filed Jan. 4, 2002; United States Patent Application No. 20090110321, entitled “Determining a Pixon Map for Image Reconstruction”, to Vija, et al., filed Oct. 31, 2007

### Image Registration and Alignment

The following are incorporated by reference herein for all purposes:

Hierarchical Model-Based Motion Estimation, James R. Bergen, P. Anandan, Keith J. Hanna, Rajesh Hingorani, European Conference on Computer Vision—ECCV, pp. 237-252, 1992

J. R. Bergen, P. J. Burt and S. Peleg. A three-frame algorithm for estimation two-component image motion. IEEE Transaction on Pattern Analysis and Machine Intelligence, 99(7):1-100, January 1992.

### Pixel Selective Fusion

The following are incorporated by reference herein for all purposes:

P. Burt. Pattern selective fusion of it and visible images using pyramid transforms. In National Symposium on Sensor Fusion, 1992

P. Burt and R. Kolczynski. Enhanced image capture through fusion. In International Conference on Computer Vision, 1993

P. Burt. The pyramid as structure for efficient computation, Multiresolution Image Processing and Analysis. Springer Verlag, 1984.

### Video Encoding

The following are incorporated by reference herein for all purposes:

Wiegand, “Overview of the H.264/AVC video coding standard”, IEEE Transactions on Circuits and Systems for Video Technology, Issue Date: July 2003 vol. 13 Issue:7 on pp. 560-576.

Richardson, “H.264 and MPEG-4 Video Compression: Video Coding for Next-generation Multimedia” 2003 John Wiley & Sons, Ltd. ISBN: 0-470-84837-5 pp. 187-194.

### Video Analytics

The following are incorporated by reference herein for all purposes:

U.S. Pat. No. 7,174,224, entitled “Smart camera”, to Hudson, et al., filed Aug. 23, 2004.

U.S. Pat. No. 7,791,671, entitled “Smart camera with modular expansion capability including a function module that performs image processing”, to Schultz, et al., filed Apr. 19, 2009.

### EMBODIMENTS

The following are embodiments, not claims:

A. A camera comprising:
a first sensor for capturing first video data;
a second sensor for capturing second video data;
circuitry operable to:
   generate first enhanced data by performing image enhancement on the first video data;
   generate first aligned data by performing image alignment on the first enhanced data;
   generate second enhanced data by performing image enhancement on the second video data;
   generate second aligned data by performing image alignment on the second enhanced data;
   generate fused data by performing video fusion of the first aligned data and the second aligned data; and
   generate encoded data by performing video encoding on the fused data.

A.10 The camera of embodiment A in which the first sensor is operable to capture the first video data in a first spectrum, and in which the second sensor is operable to capture the second video data in a second spectrum, in which the first spectrum is different from the second spectrum.

A.10.1 The camera of embodiment A in which the first spectrum is long wave infrared, and the second spectrum is visible light.

A.1 The camera of embodiment A in which the circuitry is further operable to transmit the encoded data over an Internet Protocol network.

A.x The camera of embodiment A in which, in generating the fused data, the circuitry is operable to fuse the first aligned data and the second aligned data in a pixel by pixel fashion.

A.4 The camera of embodiment A in which, in generating the fused data, the circuitry is operable to generate the fused data using the Laplacian pyramid fusion algorithm.

A.4.1 The camera of embodiment A in which, in using the Laplacian pyramid fusion algorithm, the circuitry is operable to perform a recursive computation of the Laplacian pyramid.

A.4.2 The camera of embodiment A in which, in using the Laplacian pyramid fusion algorithm, the circuitry is operable to compute double density Laplacian pyramids.

In various embodiments, data is interlaced, so there may be two ways the fusion could happen. One is to separately fuse each field, and the other is to fuse based on the full frame, in various embodiments

A.y The camera of embodiment A in which the first aligned data comprises a first field and a second field that are interlaced, and in which the second aligned data comprises a third field and a fourth field that are interlaced.

A.y.1 The camera of embodiment A.y in which, in performing video fusion, the circuitry is operable to fuse the first field and the third field, and to separately fuse the second field and the fourth field.

A.y.2 The camera of embodiment A.y in which, in performing video fusion, the circuitry is operable to fuse the full frames of the first aligned data and the second aligned data.

In various embodiments, the image may be sharpened.

A.11 The camera of embodiment A in which, in performing video fusion, the circuitry is operable to apply a sharpening algorithm to result in increased sharpness in the fused data.

A.11.1 The camera of embodiment A, in which the sharpening algorithm includes boosting high spatial frequencies in the first enhanced data and in the second enhanced data.

A.11.2 The camera of embodiment A, in which the sharpening algorithm includes performing a Laplacian pyramid fusion algorithm and adding a gain factor to Laplacian level 0.

In various embodiments, contrast may be enhanced.

A.12 The camera of embodiment A in which, in performing video fusion, the circuitry is operable to apply a contrast enhancing algorithm to result in increased contrast in the fused data.

A.12.1 The camera of embodiment A, in which the contrast enhancing algorithm includes performing a Laplacian pyramid fusion algorithm and adding a gain factor to Laplacian level 1.

In various embodiments, there may be selective contribution of the first enhanced data and the second enhanced data.

A.13 The camera of embodiment A in which, in performing video fusion, the circuitry is operable to weight the contributions of the first enhanced data and the second enhanced data to the fused data.

In various embodiments, it is determined how to weight the contribution of the first enhanced data based on some detail.

A.13.1 The camera of embodiment A in which, in performing video fusion, the circuitry is further operable to determine a level of detail in the first enhanced data, in which the contribution of the first enhanced data is weighted based on the level of detail.

In various embodiments, it is determined how to weight the contribution of the first enhanced data based on spatial frequency detail.

A.13.2 The camera of embodiment A in which, in performing video fusion, the circuitry is further operable to determine a level of spatial frequency detail in the first enhanced data, in which the contribution of the first enhanced data is weighted based on the level of spatial frequency detail.

In various embodiments, it is determined how to weight the contribution of the first enhanced data based on noise.

A.13.3 The camera of embodiment A in which, in performing video fusion, the circuitry is further operable to determine a level of noise in the first enhanced data, in which the contribution of the first enhanced data is weighted based on the level of noise.

In various embodiments, it is determined how to weight the contribution of the first enhanced data based on the presence of dark regions.

A.13.4 The camera of embodiment A in which, in performing video fusion, the circuitry is further operable to determine an existence of dark regions in the first enhanced data, in which the contribution of the first enhanced data is weighted based on the existence of the dark regions.

A.5 The camera of embodiment A in which, in generating the encoded data, the circuitry is operable to generate the encoded data using the discrete cosine transform algorithm.

A.5 The camera of embodiment A in which, in generating the encoded data, the circuitry is operable to generate an H.264 encoded internet protocol stream.

In various embodiments, the camera can enhance data in real time.

A.6 The camera of embodiment A, in which the circuitry is operable to generate the first enhanced data, the second enhanced data, the first aligned data, the second aligned data, the fused data, and the encoded data, each in real time.

In various embodiments, the camera can enhance data at a rate of 30 frames per second.

A.7 The camera of embodiment A, in which the circuitry is operable to generate the first enhanced data, the second enhanced data, the first aligned data, the second aligned data, the fused data, and the encoded data, each at a rate of at least 30 frames per second.

In various embodiments, the camera can enhance data at a rate of 60 frames per second.

A.8 The camera of embodiment A, in which the circuitry is operable to generate the first enhanced data, the second enhanced data, the first aligned data, the second aligned data, the fused date, and the encoded data, each at a rate of at least 60 frames per second.

A.z The camera of embodiment A in which the circuitry comprises a field programmable gate array system with digital signal processing coprocessors.

A.q The camera of embodiment in which the circuitry comprises a Texas Instruments DaVinci chip.

In various embodiments, there may be multiple stages of circuitry, each with separate functions.

A.w The camera of embodiment A in which the circuitry comprises:
first circuitry for performing image enhancement;
second circuitry for performing image alignment; and
third circuitry for performing image enhancement.

A.w.1 The camera of embodiment A in which the output of the first circuitry is the input to the second circuitry, and the output of the second circuitry is the input to the third circuitry.

In various embodiments, where one sensor fails, another may be used.

B. A camera comprising:
a first sensor for capturing first video data;
a second sensor for capturing second video data;
circuitry operable to:
   generate first enhanced data by performing image enhancement on the first video data;
   determine that the second sensor is not functioning properly; and
   generate, based on the determination that the second sensor is not functioning properly, encoded data by performing video encoding only on the first video data.

The following are embodiments, not claims:

A. A camera comprising:
a first sensor for capturing first video data;
a second sensor for capturing second video data;
circuitry operable to:
   generate first enhanced data by performing image enhancement on the first video data;
   generate first aligned data by performing image alignment on the first enhanced data;
   generate second enhanced data by performing image enhancement on the second video data;
   generate second aligned data by performing image alignment on the second enhanced data;
   generate fused data by performing video fusion of the first aligned data and the second aligned data;
   generate analytics data based on the fused data; and
   generate encoded data by performing video encoding on the fused data.

A.25 The camera of embodiment A in which the analytics data is generated using affine global motion estimation on the fused data.

A.26 The camera of embodiment A in which the analytics data is generated using local motion estimation on the fused data.

A.24 The camera of embodiment A, in which the circuitry is further operable to transmit the analytics data over an Internet Protocol channel.

A.25 The camera of embodiment A, in which the circuitry is further operable to transmit the analytics data together with the fused data over an Internet Protocol channel.

A.23 The camera of embodiment A in which the analytics data includes an indication of activity detected in the fused data.

A.27 The camera of embodiment A in which the analytics data includes an indication of motion detected in the fused data.

A.28 The camera of embodiment A in which the analytics data includes an identification of an object in the fused data.

A.28.0 The camera of embodiment A in which the analytics data includes an indication that the object is a new object.

A.28.1 The camera of embodiment A.28 in which the analytics data includes an indication of a path of the object detected in the fused data.

A.28.2 The camera of embodiment A.28 in which the analytics data includes an indication of location of the object detected in the fused data.

A.28.3 The camera of embodiment A.28 in which the analytics data includes an indication of geo-location of the object detected in the fused data.

A.28.4 The camera of embodiment A.28 in which the analytics data includes an indication of two locations of the object detected in the fused data, in which the two locations correspond to locations of the object at two different times.

A.28.5 The camera of embodiment A in which the analytics data includes a classification of the object in the fused data.

A.28.5.1 The camera of embodiment A in which the analytics data includes a classification as human of the object in the fused data.

A.28.5.1 The camera of embodiment A in which the analytics data includes a classification as vehicle of the object in the fused data.

A.28.6 The camera of embodiment A in which the analytics data includes an indication that the object has been abandoned.

A.29 The camera of embodiment A in which the analytics data includes an indication that a perimeter has been breached.

A.22 The camera of embodiment A in which the analytics data includes an indication of a disappearance of an object detected in the fused data.

1. A camera comprising:
a first sensor for capturing first video data;
a second sensor for capturing second video data;
circuitry operable to:
generate first enhanced data by performing image enhancement on the first video data;
generate first aligned data by performing image alignment on the first enhanced data;
generate second enhanced data by performing image enhancement on the second video data;
generate second aligned data by performing image alignment on the second enhanced data;
generate fused data by performing video fusion of the first aligned data and the second aligned data;
generate analytics data based on the fused data; and
generate encoded data by performing video encoding on the fused data.

2. The camera of claim 1 in which the analytics data is generated using affine global motion estimation on the fused data.

3. The camera of claim 1 in which the analytics data is generated using local motion estimation on the fused data.

4. The camera of claim 1, in which the circuitry is further operable to transmit the analytics data over an Internet Protocol channel.

5. The camera of claim 1, in which the circuitry is further operable to transmit the analytics data together with the fused data over an Internet Protocol channel.

6. The camera of claim 1 in which the analytics data includes an indication of activity detected in the fused data.

7. The camera of claim 1 in which the analytics data includes an indication of motion detected in the fused data.

8. The camera of claim 1 in which the analytics data includes an identification of an object in the fused data.

9. The camera of claim 1 in which the analytics data includes an indication that the object is a new object.

10. The camera of claim 8 in which the analytics data includes an indication of a path of the object detected in the fused data.

11. The camera of claim 8 in which the analytics data includes an indication of location of the object detected in the fused data.

12. The camera of claim 8 in which the analytics data includes an indication of geo-location of the object detected in the fused data.

13. The camera of claim 8 in which the analytics data includes an indication of two locations of the object detected in the fused data, in which the two locations correspond to locations of the object at two different times.

14. The camera of claim 1 in which the analytics data includes a classification of the object in the fused data.

15. The camera of claim 1 in which the analytics data includes a classification as human of the object in the fused data.

16. The camera of claim 1 in which the analytics data includes a classification as vehicle of the object in the fused data.

17. The camera of claim 1 in which the analytics data includes an indication that the object has been abandoned.

18. The camera of claim 1 in which the analytics data includes an indication that a perimeter has been breached.

19. The camera of claim 1 in which the analytics data includes an indication of a disappearance of an object detected in the fused data.
